(19) United States
(12) Patent Application Publication
(10) Pub. No.: US 2005/0280634 A1
(43) Pub. Date: Dec. 22, 2005

(54) Input panel and input device using the panel

(75) Inventors: Koji Tanabe, Osaka (JP); Minoru Karaki, Okayama (JP); Tetsutaro Nasu, Nara (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/117,332

(22) Filed: Apr. 29, 2005

(30) Foreign Application Priority Data
Jun. 21, 2004 (JP) 2004-182641

(51) Int. Cl. G09G 5/00

(52) U.S. Cl. 345/173

(57) ABSTRACT

An input panel which includes at the top of the upper substrate a flexible display section working on the electric-charge principle for displaying letters and drawings written with an electric-charge pen. Letters and drawings being written for entry are displayed on the display section, so an inputting operator can see and confirm with his or her eyes the letters and drawings being written. The present input panel contributes to make inputting operations easier, and free of writing mistakes and input errors.

### FIELD OF THE INVENTION

The present invention relates to an input panel used for inputting letters and drawings, etc. to various kinds of electronic apparatus.

### BACKGROUND OF THE INVENTION

Portable telephone units, portable data terminals and the like electronic apparatus have become increasingly multifunctional and sophisticated. Many of such apparatus have an input panel at the front face of the case to form a sort of input device, so that operations of inputting letters and drawings to the apparatus can be made through the input device by pressing the panel surface with a finger or a dedicated pen. The input panels are required to be easy-to-operate, and insure error-free operations.

Japanese Patent Unexamined Publication No. 2003-280821 discloses an input panel. In the following, a conventional input panel is described with reference to FIG. 7. For the sake of easier understanding, the drawing is shown magnified in the dimensions along the direction of panel thickness.

FIG. 7 shows a cross sectional view of a conventional input panel. film-shape upper substrate 1 has, at the lower surface, upper conductive layer 3 formed of indium tin oxide (ITO) or the like material. Film-shape lower substrate 2 has, at the upper surface, lower conductive layer 4 formed of ITO or the like material. There is a plurality of dot spacers (not shown) made of an insulating resin material provided on the upper surface of lower conductive layer 4 at a certain specific interval. Upper conductive layer 3 has a pair of upper electrodes (not shown) at both sides; lower conductive layer 4 has a pair of lower electrodes (not shown) at both sides disposed in the direction perpendicular to the upper electrodes.

Upper substrate 1 and lower substrate 2 are glued together along the outer circumference with an adhesive agent (not shown) applied on the upper and lower surfaces of frame-shaped spacer 5. Thus the input panel includes upper conductive layer 3 and lower conductive layer 4 opposing to each other with a certain specific clearance in between.

The above-described input panel is mounted on the front face of an electronic apparatus' case (not shown). The upper and lower electrodes of the input panel are connected to a control circuit formed of a microcomputer or the like means (not shown). A display device such as an LCD (not shown) connected to the control circuit is provided in the neighborhood of the input panel. In such a setup, when a dedicated pen, etc. makes contact onto the upper surface of upper substrate 1, upper substrate 1 is bent at the place of contact made with the pen and upper conductive layer 3 is brought to make contact with lower conductive layer 4.

A voltage is applied from the control circuit on the upper electrode and to the lower electrode, and the place of contact is detected by the control circuit in terms of voltage ratio between the electrodes. In this way, function of an electronic apparatus can be switched to other different operation stages.

When letters or drawings are written on the panel by dragging a dedicated pen along the upper surface of upper substrate 1, the control circuit recognizes a pattern of the letters and drawings by detecting the places of contact in the same procedure as described in the above. The letters and drawings are displayed on, for example, a display device provided in the neighborhood.

On a display screen, an operator makes selection on displayed letters and drawings by making use of a key (not shown) coupled with the control circuit; and then, enters a selected result.

In the conventional input panels, however, it is not easy for an operator to see and confirm with his or her eyes the letters and drawings being written on the panel; therefore, it is necessary to provide a display device or the like means somewhere in the neighborhood in order to show what is being written.

Furthermore, when adding a new letter or giving an extension to an existing line after once lifting the pen off the panel, it is not quite easy for an operator to locate a right place where to start. This would easily lead to a dislocated pen touch or a writing error, rendering correct inputting difficult. An outstanding task is how to ensure an accurate inputting of letters and drawings through a panel.

### SUMMARY OF THE INVENTION

The present invention offers an input panel, in which a display section is provided at the top of upper substrate or at the bottom of lower substrate for displaying letters and drawings being written on the panel by a contact made with a certain specific pen. An input panel in the present invention displays letters and drawings being written for entry on the display section. An operator using the present input panel can observe what is being written for entry. Therefore, operations for inputting letters and drawings become easier, and a possible writing error or a wrong entry can be prevented. The present invention also offers an input device which includes the above input panel.

### BRIEF DESCRIPTION OF THE DRAWINGS

FIG. 1 is a cross sectional view of an input panel in accordance with first embodiment of the present invention.

FIG. 2 is a cross sectional view, showing a part of the input panel of FIG. 1.

FIG. 3 is a cross sectional view of an input panel in accordance with second embodiment of the present invention.

FIG. 4 is a cross sectional view, showing a part of the input panel of FIG. 3.

FIG. 5 is a cross sectional view of an input panel in accordance with third embodiment of the present invention.

FIG. 6 is a plan view of an input device in accordance with fourth embodiment of the present invention.

FIG. 7 shows a cross sectional view of a conventional input panel.

### DETAILED DESCRIPTION OF PREFERRED EMBODIMENTS

An input panel in accordance with the present invention includes a display section for displaying letters and drawings written by a contact made with a certain specific pen, which display section being disposed either on the top of upper substrate or at the bottom of lower substrate. The letters and drawings being written for entry are displayed on the display section. So, an operator can see with the eyes what he or she is writing for entry. Thus the present input panel is easy-to-use for an operator, and the letters and drawings can be written correctly and entered error-free.

An input panel in the present invention includes an EL panel disposed either between the display section and the upper substrate, or underneath the lower substrate. The EL panel illuminates the display section from underneath to facilitate easy operation in a dark working environment.

In an input panel in the present invention, the upper conductive layer and the lower conductive layer are coupled with a control circuit. The control circuit recognizes a pattern of the letters and drawings by detecting the points of contact between the upper conductive layer and the lower conductive layer caused by a pressure due to a certain specific pen. An input device is thus provided. The input device is easy-to-use for inputting letters and drawings, and facilitates error-free operations.

In an input device in the present invention, a control circuit erases, using an erasing means, letters and drawings displayed on the display section. After an entry of certain letters and drawings is finished, the displayed letters and drawings are erased to be ready for the next consecutive entry. Thus the input device is made to be more user-friendly.

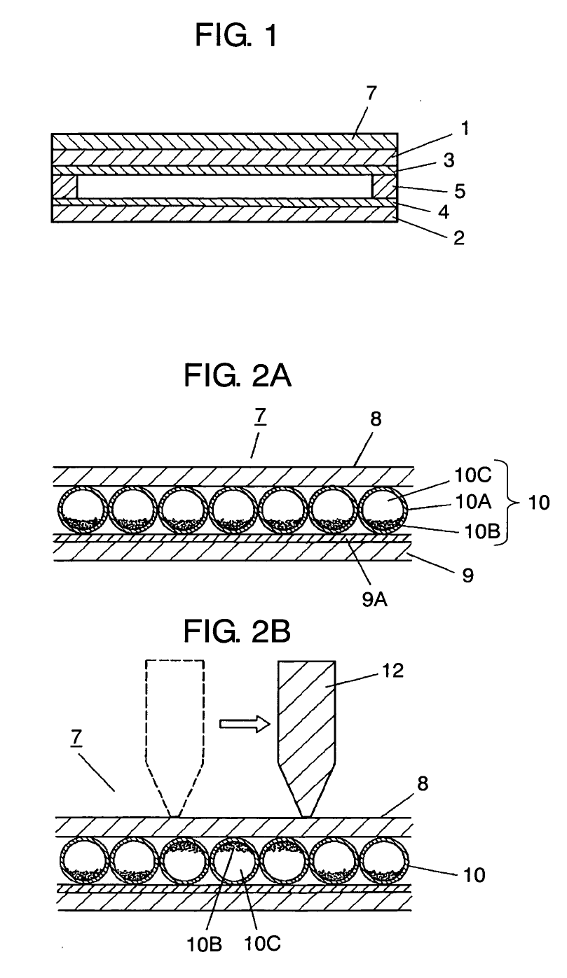

Now in the following, exemplary embodiments of the present invention are described in detail referring to the drawings FIG. 1-FIG. 6. The drawings are for presenting the concept of invention; they are not intended to exhibit precise dimensions and relative locations. For easier understanding of the structures, the drawings have been magnified in the dimensions along the direction of panel thickness.

Those portions whose structure is identical to those described earlier in the Background of the Invention are designated with the same symbols or marks, and detailed description on which is eliminated.

### FIRST EMBODIMENT

First exemplary embodiment of the present invention is described with reference to FIG. 1 through FIG. 2B. Referring to FIG. 1, upper substrate 1 is a film made of polyethylene terephthalate (PET), polycarbonate (PC) or the like material. Lower substrate 2 is made of a glass, an acrylic resin, PC, etc.

Upper substrate 1 has upper conductive layer 3 formed on the lower surface, while lower substrate 2 has lower conductive layer 4 formed on the upper surface. These conductive layers are formed of ITO, tin oxide, carbon or polythiophene, etc. through a sputtering or a coating process.

On the upper surface of lower conductive layer 4, a plurality of dot spacers (not shown) are disposed at a certain interval, which dot spacers being made of an insulating material such as epoxy resin, silicone resin, etc. At both sides of upper conductive layer 3, a pair of upper electrodes (not shown) is provided using silver, carbon, etc. At both sides of lower conductive layer 4, a pair of lower electrodes (not shown) is provided in the direction perpendicular to the upper electrodes.

Upper substrate 1 and lower substrate 2 are glued together along the outer circumference with an adhesive agent (not shown) applied at the upper and the bottom surfaces of frame-shaped spacer 5.

Thus upper conductive layer 3 and lower conductive layer 4 are disposed opposed with a certain specific clearance in between.

Flexible display section 7 displays letters and drawings written by a contact made with a certain specific pen. Display section 7 operating on the electric charge principle is disposed on the upper surface of upper substrate 1 to complete a finished electric-charge type input panel.

As shown in FIG. 2A, electric-charge type display section 7 is formed with upper sheet 8 made of PET film or PC film, etc. and lower sheet 9 of the like film material having, on the upper surface, conductive layer 9A made of ITO, tin oxide, carbon or polythiophene, etc. These sheets are sealed together along the outer circumference.

Between upper sheet 8 and lower sheet 9, micro capsules 10 are sandwiched. Micro capsule 10 is formed of transparent, or semi-transparent, outer skin 10A made of gelatin, acryl, nylon, polyvinyl alcohol (PVA), urethane, melamine, ethyl cellulose or alumina, etc.; and contains in the inside of the outer skin negative-charged black micro gains 10B of carbon, etc., and non-charged white micro grains 10C of titanium oxide, etc. and a small portion of dispersion stabilizer such as a surface active agent.

Between upper sheet 8 and lower sheet 9 is filled with water or other kinds of liquid such as mineral oil, vegetable oil, silicone oil, fluoric system oil, etc. Electric-charge type display section 7 is thus provided.

In the state where lower sheet 9's conductive layer 9A is applied with a positive potential, negative-charged black micro grains 10B of carbon, etc. are electrophoretically segregated to be staying at the bottom of micro capsule 10, as shown in FIG. 2A. The upper part of micro capsule 10 is dispersed with charge-free white micro grains 10C of titanium oxide, etc. As viewed from above upper sheet 8, the entire area of display section 7 appears to be evenly white. The white appearance stays as it is even after the potential on conductive layer 9A is withdrawn.

The letters or drawings are written with electric-charge pen 12, which has a built-in electronic circuit and battery, by having its positive-charged tip-end making contact on the upper surface of electric-charge type display section 7 and dragging it on the surface along the pattern of a letter or a drawing. When, the negative-charged black micro grains 10B in micro capsules 10 locating underneath the trace of charge pen 12 are electrophoretically segregated to be staying at the upper part. The arrow mark in the drawing indicates the dragging direction of charge pen 12. As viewed from above upper sheet 8, the trace of charge pen 12 appears black in the white background. Thus an operator can see and confirm clearly the letters or drawings written.

After letters or drawings have been written in black, if lower sheet 9's conductive layer 9A is once again applied with a positive potential the black micro grains 10B are electrophoretically segregated to the lower part of micro capsule 10 as shown in FIG. 2A. When, the upper part is dispersed white micro grains 10C, and the whole surface looks white.

The above-configured input panel is mounted at the front face of an electronic apparatus' case (not shown), and the upper and lower electrodes are connected with a control circuit (not shown) formed of a microcomputer, etc. And, an LCD or the like display device (not shown) coupled with the control circuit is disposed in the neighborhood of the input panel.

In the above setup, when electric-charge pen 12 makes contact to press a certain place of the upper surface of display section 7, the pressing force bends upper substrate 1 via display section 7, so that upper conductive layer 3 makes contact with lower conductive layer 4 at the place of contact pressure.

A voltage is applied from the control circuit on the upper electrode and to the lower electrode, and the place of contact is detected by the control circuit in terms of voltage ratio between the electrodes. In this way, a function of an electronic apparatus can be switched to other different operation stages.

When letters or drawings are written on the panel by dragging electric-charge pen 12 along the upper surface of display section 7, the control circuit recognizes a pattern of the letters and drawings by detecting the places of contact in the same procedure as described earlier. The letters and drawings are displayed on, for example, a display device disposed in the neighborhood.

When, the negative-charged black micro grains 10B of carbon, etc. contained in micro capsules 10 underneath the trace of electric-charge pen 12 are electrophoretically segregated to be staying at the upper part, and the trace of electric-charge pen 12 appears black in the white background. Thus an operator can clearly see and recognize the letters or drawings to be entered.

As described in the above, an electric-charge type input panel in the present embodiment includes flexible electric-charge type display section 7 disposed at the top of upper substrate 1 for displaying letters and drawings written on display section 7 with electric-charge pen 12. During an inputting operation, an operator can see and confirm with the eyes on display section 7 the letters and drawings being written for entry. Thus the present invention offers an easy-to-use electric-charge type input panel, with which an operation of inputting letters and drawings becomes much easier, and a possible writing error or a wrong entry can be prevented.

The above descriptions have been based on the structure where display section 7 is disposed at the top of upper substrate 1. However, the present invention can be embodied also in other structures; for example, display section 7 may be disposed beneath lower substrate 2, after making upper substrate 1 and lower substrate 2 transparent and forming upper conductive layer 3 as well as lower conductive layer 4 with ITO, tin oxide or the like transparent material.

The above descriptions have been based on the structure of electric-charge type display section 7 where micro capsules 10 sandwiched between upper sheet 8 and lower sheet 9 contain negative-charged black micro grains 10B of carbon, etc. and charge-free white micro grains 10C of titanium oxide, etc. However, the present invention can be embodied also with other type micro capsules; for example, a micro capsule which contains a mixture of two or more kinds of grains or color liquids, each having different color contrast and one among them is charged either positive or negative.

In place of the above-described display section 7 which includes micro capsules 10 disposed between the upper and the lower sheets, the electric-charge type display section can be provided in a different structure; namely, by stacking on the upper surface of lower sheet 9's conductive layer 9A an electro-chromic (EC) material, such as a Prussian Blue complex which changes its color from colorless to blue when a positive potential is applied.

Another EC material changing the color from colorless to blue upon positive potential is Ir(OH)n. Whereas, Ni(OH)n changes its color from brown to blue.

Those who change its color upon negative potential from colorless to blue include WO₃, MoO₃, Nb₂O₅, etc.

### SECOND EMBODIMENT

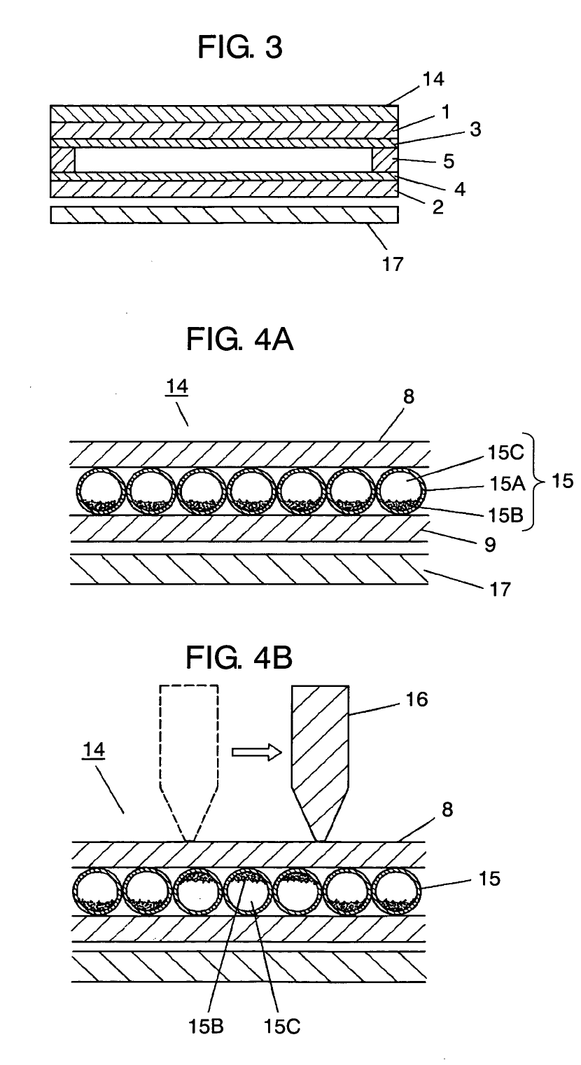

Second embodiment of the present invention is described with reference to FIG. 3 through FIG. 4B.

Those structures identical to those in the first embodiment are designated with the same symbols, and detailed description on which is eliminated.

In the same manner as in the first embodiment, upper substrate 1 and lower substrate 2 are glued together at the outer circumference with frame-shaped spacer 5 in between, as shown in FIG. 3. Upper conductive layer 3 at the lower surface of upper substrate 1 and lower conductive layer 4 at the upper surface of lower substrate 2 are thus disposed opposed with a certain specific clearance in between.

That the letters and drawings written by a contact made with a certain specific pen are displayed on the upper surface of upper substrate 1, and that it has flexible display section 14 remain the same as an input panel in the first embodiment. The point of difference with an input panel in accordance with the present embodiment is that display section 14 works on the magnetic principle, comparing to the electric-charge type of the first embodiment. Furthermore, there is electro-magnet 17 disposed under lower substrate 2. A magnetic type input panel is thus structured.

Magnetic display section 14 includes, as shown in FIG. 4A, upper sheet 8 made of a film of PET or PC, etc. and lower sheet 9 of likewise film, the two sheets are sealed together along the outer circumference. Upper sheet 8 and lower sheet 9 sandwich micro capsules 15 in between. Micro capsule 15 has transparent, or semi-transparent, outer skin 15A which is made of gelatin, acryl, nylon, PVA, urethane, melamine, ethyl cellulose or alumina, etc.; contained in the inside of outer skin are magnetic black micro grains 15B of iron oxide, etc., non-magnetic white micro grains 15C of titanium oxide, etc. and a small portion of dispersion stabilizer such as a surface active agent.

Furthermore, the space between upper sheet 8 and lower sheet 9 is filled with water or other kinds of liquid such as mineral oil, vegetable oil, silicone oil, fluoric system oil, etc. Magnetic display section 14 is thus structured.

In the state when electro-magnet 17 disposed under lower substrate 2 is activated with electricity, magnetic black micro grains 15B are magneto-phoretically segregated to be staying at the bottom of micro capsule 15, as shown in FIG. 4A. Whereas the upper part of micro capsule 15 is dispersed with non-magnetic white micro grains 15C of titanium oxide, etc. As viewed from above upper sheet 8, the entire area appears to be evenly white. The white appearance stays as it is even after delivery of the voltage to electro-magnet 17 is discontinued.

When magnetic pen 16 makes contact at the magnetized tip-end on the upper surface of magnetic display section 14 and dragged along the surface in the shape of a letter or a drawing, magnetic black micro grains 15B in micro capsules 15 locating underneath the trace of magnetic pen 16 are magneto-phoretically segregated to be staying at the upper part. The arrow mark in the drawing indicates the dragging direction of magnetic pen 16.

As viewed from above upper sheet 8, the trace of magnetic pen 16 appears black in the white background. Thus an operator can clearly see and recognize with the eyes the letters and drawings written for entry.

After letters and drawings have been written in black, when electro-magnet 17 is activated once again, black micro grains 15B of iron oxide, etc. are magneto-phoretically segregated to be staying at the lower part of micro capsule 15, while the upper part is dispersed with non-magnetic white micro grains 15C of titanium oxide, etc. Thus the entire area returns to the evenly white appearance.

The above-configured input panel is mounted at the front face of an electronic apparatus' case (not shown), and the upper and lower electrodes are connected to a control circuit (not shown) formed of a microcomputer, etc.

When magnetic pen 16 makes contact at the magnetized tip-end to the upper surface of display section 14, the pressing force bends upper substrate 1 via display portion 14 so that upper conductive layer 3 makes contact with lower conductive layer 4 at the place of pen contact. The control circuit detects the place of contact through the voltage ratio between the electrodes. Thus, function of an electronic apparatus can be switched to other different operating stages.

When letters and drawings are written with magnetic pen 16 by dragging it along the upper surface of display section 14, magnetic black micro grains 15B move magneto-phoretically to the upper part of micro capsule 15. As the result, the trace of magnetic pen 16 appears black in the white background, and the letters and drawings are shown with black lines in the white background of display section. During input operations, an operator can clearly see and confirm what is written for entry.

In a magnetic type input panel in accordance with the present embodiment, where flexible magnetic display section 14 for displaying letters and drawings written by a contact made with magnetic pen 16 is disposed on the upper surface of upper substrate 1, an input operator can see with the eyes what is being written on display section 14. Thus a magnetic input panel in the present invention makes input operations easier and error-free.

The above descriptions have been based on the structure where electro-magnet 17 is disposed underneath lower substrate 2 for erasing letters and drawings displayed on display section 14 by supplying electricity to the electro-magnet. However, the present invention can be embodied also in other structures; for example, providing a permanent magnet under lower substrate 2, and erasing displayed letters and drawings by shifting the relative position between the permanent magnet and display section 14.

The above descriptions have been based on the structure of magnetic display section 14, where micro capsules 15 disposed between upper sheet 8 and lower sheet 9 contain magnetic black micro grains 15B of carbon, etc. and non-magnetic white micro grains 15C of titanium oxide, etc. However, the present invention can be embodied also with other type micro capsules; for example, a micro capsule which contains dispersed micro flakes of iron, etc. Orientation of which micro flakes can be changed using electro-magnet 17 or a permanent magnet, etc.

In the above-described example, when the micro flakes in the micro capsule are orientated horizontal by the effect of electro-magnet 17 or a permanent magnet, etc. the micro flakes reflect incident light to create a bright state. On the other hand, when the micro flakes are orientated to be vertical by magnetic pen 16, etc. the light passes through the capsule and a dark state is created. Thus, letters and drawings can be written with dark lines in the bright background.

A magnetic display section using the iron flakes can be implemented with such micro flakes whose thickness is approximately 1 μm, width 3-5 μm and length 10-20 μm. Then, the diameter of micro capsule can be made to be 80-100 μm, which would be an advantage for making the overall contour thinner.

### THIRD EMBODIMENT

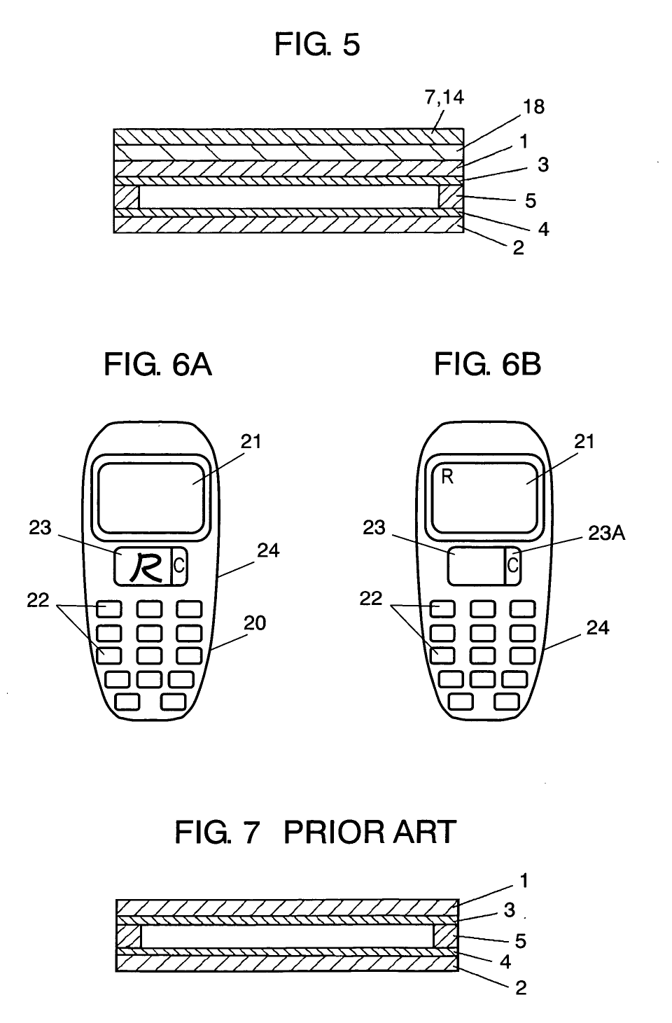

Third embodiment of the present invention is described referring to FIG. 5. Those items identical to those in the first, second embodiments are designated with the same symbols, and detailed description on which is eliminated. Like in the first and the second embodiments, upper substrate 1 and lower substrate 2 are glued together at the outer circumference with frame shaped spacer 5 in between. Upper conductive layer 3 at the lower surface of upper substrate 1 and lower conductive layer 4 at the upper surface of lower substrate 2 are disposed opposed with a certain specific clearance in between.

On the upper surface of upper substrate 1, electric-charge type display section 7 or magnetic display section 14 is disposed in the same manner as in the first, second embodiments for displaying letters and drawings written by a contact with a certain specific pen. An input panel in the present embodiment is further provided with electroluminescence (EL) panel 18 disposed between display section 7, 14 and upper substrate 1. EL panel 18 is a dispersion type and flexible; made with a film of PET or PC, etc., which is provided at the lower surface with a transparent electrode layer, a light emitting layer, a dielectric layer, a back electrode layer, etc. printed overlaid one after the other.

The above-configured input panel is mounted on the front face of an electronic apparatus' case (not shown), with the upper electrode and the lower electrode connected to a control circuit (not shown) formed of a microcomputer, etc. When the upper surface of display section 7, 14 is pressed by electric-charge pen 12 or magnetic pen 16, the control circuit detects the place of contact through the same procedure as described earlier in the first or the second embodiment. Thus, function of an electronic apparatus can be switched to other different operation stages.

When letters or drawings are written with electric-charge pen 12 or magnetic pen 16 by dragging it along the upper surface of display section 7, 14, the letters and drawings are displayed on the display section. So far, it remains the same as that in the first and second embodiments. In the present embodiment, display section 7, 14 is illuminated by EL panel 18 from underneath. Namely, in the dark environment, EL panel 18 is turned ON to generate light for illuminating the display section, so that an operator can precisely see and recognize the letters and drawings written.

In an input panel in the present embodiment, which includes EL panel 18 disposed between display section 7, 14 and upper substrate 1, display section 7, 14 is illuminated by EL panel 18 from underneath. Thus, this makes the inputting operation to display section easier even in a dark working environment.

Display section 7, 14 in the present embodiment needs to be transparent, or semi-transparent. Such a display section can be provided by optimizing the grain sizes of black micro grains 10B of carbon, etc., white micro grains 10C of titanium oxide, etc. and black micro grains 15B of iron oxide, etc.; for example, reducing the grain diameter to less than several tens nanometer, or shorter than the wavelength of visible light, 400-700 nm. Or, by controlling dosing quantities of these grains or particles.

The above descriptions have been based on the structure where EL panel 18 is disposed between display section 7, 14 and upper substrate 1. However, the same advantage can be offered also by disposing EL panel 18 underneath lower substrate 2; after providing upper substrate 1, lower substrate 2, upper conductive layer 3 and lower conductive layer 4 in a transparent configuration as described earlier in the first embodiment. In this structure, light emitting diode which is a popular light source for LCD or a cathode ray tube can be employed for illuminating display section 7, 14 from under lower substrate 2. As compared to these substitute light sources, film-shaped EL panel 18 in the present embodiment is advantageous in designing the overall contour flat.

### FOURTH EMBODIMENT

Fourth embodiment of the present invention is described referring to FIG. 6A, 6B.

Those portions having the same structure as those in the first, second and third embodiments are designated with the same symbols, and detailed description on which is eliminated.

FIG. 6A is a plan view of a portable telephone unit, or an input device in accordance with fourth embodiment of the present invention. Case 20 made of an insulating resin has display device 21 made of LCD, etc. at the upper front, and a plurality of push keys 22 at the lower front.

Disposed in the middle face of case 20 is input panel 23 described in the first, second and third embodiments. Inside the case 20, a circuit board (not shown) mounted with a microcomputer and other electronic components is housed forming control circuit 24.

Input panel 23's upper conductive layer 3, lower conductive layer 4, conductive layer 9A, electro-magnet 17, and display device 21, push keys 22 are connected to control circuit 24 to complete a finished input device.

When a user makes phone call, for example, using the above-configured telephone unit, he or she presses push keys 22 to have a phone number displayed on display device 21. And then presses one of the push keys for transmission.

When a user drafts an e-mail message or compiles a telephone directory, he or she has to press a certain specific key among push keys 22, and then starts pressing a number of letter-bearing keys 22, makes a selection and fixing at each step, to have a sentence or a name list displayed on display device 21. And then, an action for message transmission or name list entry, etc. follows.

Besides the above-described complex procedure needed when inputting letters and drawings through push keys 22, input panel 23 of an input device in the present invention offers a simplified input procedure.

The simplified input procedure is described in the below.

For inputting a letter “R”, for example; write the letter “R” on input panel 23 with electric-charge pen 12, or magnetic pen 16, pressing and dragging the pen along the upper surface of display section 7, 14. Control circuit 24 detects the places of contact caused between upper conductive layer 3 and lower conductive layer 4 due to the pen pressure, by way of the same principle as described in the first and second embodiments. Thus a pattern of handwriting “R” is recognized, and which pattern is displayed as it is on input panel 23, as shown in FIG. 6A.

After a certain time elapsed, or a certain specific key of push keys 22 is pressed, control circuit 24 identifies a letter “R” based on the handwritten pattern “R” through a pattern recognition process, and displays a letter “R” which is taken out of those letters stored in memory, or a letter that is identical to the handwritten pattern “R”, on display device 21, as shown in FIG. 6B.

At the same time, control circuit 24 delivers electricity to erasing means, conductive layer 9A or electro-magnet 17, to erase the handwritten pattern “R” being displayed on input panel 23. And then, a press of a certain specific key among push keys 22 selects, fixes and enters the letter “R”.

As described in the above, an operator can draft a mail message or compile a name list with ease, by writing letters or drawings on input panel 23 with a certain specific pen. The letters and drawings being written can be seen and confirmed with the eyes, and what has been displayed on input panel 23 is erased at each time. Thus the present input device facilitates easy and consecutive input operations.

In a case when there is a writing error with a written letter or drawing, or a wrong letter is recognized, an operator may press a region C provided at the right side of input panel 23 for clearing. Control circuit 24 detects it and cleans what is being displayed.

As described in the above, an input device in the present embodiment recognizes a pattern of letters and drawings written on input panel 23 with a certain specific pen, by way of detection by control circuit 24 of contact places between upper conductive layer 3 and lower conductive layer 4. Thus the present invention offers an input device that is easy-to-use and error-free.

Furthermore, at the end of each of the inputting stages, letters and drawings displayed on display section 7, 14 are erased by an erasing means, conductive layer 9A or electro-magnet 17, etc. in accordance with an instruction sent from control circuit 24. Therefore, an operator can continue input operations consecutively. This makes the input device more user-friendly.

Input panels in accordance with the present invention and input devices using the input panel make the operations for inputting letters and drawings easier, and reduce the possibility of errors by an operator. These panels and devices can be mounted on various kinds of electronic apparatus as means for switching their operation to other different functions.

1. An input panel comprising
an upper substrate provided at the lower surface with an upper conductive layer,
a lower substrate provided at the upper surface with a lower conductive layer, which conductive layer opposing to the upper conductive layer with a certain specific clearance in between, and
a display section disposed either on the top surface of the upper substrate or at the lower surface of the lower substrate, for displaying letters and drawings written by a contact made with a certain specific pen.

2. The input panel of claim 1, wherein
the display section comprises micro capsules.

3. The input panel of claim 2, further comprising
an EL panel disposed either between the display section and the upper substrate or at the lower surface of the lower substrate.

4. An input device comprising:
an input panel, which panel comprising
an upper substrate provided at the lower surface with an upper conductive layer,
a lower substrate provided at the upper surface with a lower conductive layer, which conductive layer opposing to the upper conductive layer with a certain specific clearance in between, and
a display section disposed either on the top surface of the upper substrate or at the lower surface of the lower substrate, for displaying letters and drawings written by a contact made with a certain specific pen; and
a control circuit coupled with the input panel's upper conductive layer and lower conductive layer; wherein
the control circuit recognizes a pattern of letters and drawings from the points of contact caused between the upper conductive layer and the lower conductive layer by a pressure given with the certain specific pen.

5. The input device of claim 4, wherein
the display section comprise micro capsules.

6. The input panel of claim 5, further comprising
an EL panel disposed either between the display section and the upper substrate or at the lower surface of the lower substrate.

7. The input device of claim 6, wherein
the control circuit erases letters and drawings displayed on the display section using an erasing means.

8. The input device of claim 7, wherein
the erasing means erases the display by supplying electricity to a conductive layer or to an electro-magnet.
